(19) United States
(12) Patent Application Publication
(10) Pub. No.: US 2024/0378256 A1
(43) Pub. Date: Nov. 14, 2024

(54) Artificial Intelligence Generated Badges for Search

(71) Applicant: Google LLC, Mountain View, CA (US)

(72) Inventors: Arash Sadr, Belmont, CA (US); Yu Tao, Zürich (CH); Daliang Li, New York, NY (US); Zachary Kenneth Fisher, Mountain View, CA (US); Bhargav Kanagal Shamanna, Fremont, CA (US); Xinnan Yu, Forest Hills, NY (US); Rajiv Shailendra Menjoge, Menlo Park, CA (US); Marcin Tadeusz Bialek, Zürich (CH); Grzegorz Glowaty, Kilchberg (CH); Sumit K. Sanghai, Sunnyvale, CA (US); Sanjiv Kumar, Jericho, NY (US)

(21) Appl. No.: 18/636,844

(22) Filed: Apr. 16, 2024

Related U.S. Application Data
(60) Provisional application No. 63/501,123, filed on May 9, 2023.

(51) Int. Cl. G06F 16/9538; G06F 40/30; G06Q 30/0282; G06Q 30/0601

(52) U.S. Cl. CPC G06F 16/9538; G06F 40/30; G06Q 30/0282; G06Q 30/0633

(57) ABSTRACT

Systems and methods for generating and utilizing artificial intelligence generated badges can include processing web information associated with a subject to determine particular qualities of the subject. The qualities can then be utilized to generate one or more badges. The badges can then be utilized for search result determination and display. The badges may be utilized for search result ranking and may be utilized to annotate search results in a search results interface.

### PRIORITY CLAIM

The present application is based on and claims priority to U.S. Provisional Application No. 63/501,123 having a filing date of May 9, 2023. Applicant claims priority to and the benefit of each of such application and incorporates all such applications herein by reference in its entirety.

### FIELD

The present disclosure relates generally to artificial intelligence generated badges for search. More particularly, the present disclosure relates to generating badges for search results based on processing web information associated with a subject with one or more machine-learned models to determine particular uses and/or advantages for that particular subject that can then be utilized to rank and/or annotate search results.

### BACKGROUND

Different objects and environments can have differing uses, pros, and/or cons. For example, different products may be better for particular locations and/or particular users. However, discerning which product excels for certain uses can be difficult when reviewing a traditional search results page.

For example, traditional search results can provide a plurality of web resources to a user based on traditional text query processing; however, the search result list alone may provide minimal information to the user unless the user selects the search result and is navigated to the associated web page. The navigation to and from the search result page to different landing pages can be time consuming and overall unproductive. Additionally, traditional search result pages can be redundant and/or lack organization.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include obtaining web data associated with a particular product. The web data can include web information associated with the particular product. The operations can include processing the web data with one or more machine-learned models to determine one or more particular uses associated with the particular product. The one or more particular uses can be determined based on the web information. The operations can include generating one or more badges based on the one or more particular uses. In some implementations, the one or more badges can be descriptive of the one or more particular uses. The operations can include storing the one or more badges. The one or more badges can be stored with data descriptive of an association with the particular product. The operations can include obtaining a search query. In some implementations, the search query can be associated with a product type. The particular product can be of the product type. The operations can include providing a search results interface based on the search query and the one or more badges.

In some implementations, the web data can include user reviews of the particular product. The one or more particular uses can be determined based on a frequency of a term in the web information, sentiment analysis, and semantic understanding. The one or more particular uses can be associated with at least one of: a scenario for using the particular product, a purpose for using the particular product, a time for using the particular product, or a type of user that uses the product.

In some implementations, the operations can include processing the one or more badges with an embedding model to generate one or more respective badge embeddings in an embedding space and determining a plurality of search results to display in the search results interface based on the one or more badge embeddings. Determining the plurality of search results can include processing the search query with the embedding model to generate a query embedding, determining the query embedding is associated with the badge embedding, and providing a product search result descriptive of the particular product in the search results interface. The operations further can include processing a plurality of other badges associated with a plurality of other products with the embedding model to generate a plurality of other badge embeddings, determining one or more badge clusters based on one or more badge embeddings and the plurality of other badge embeddings, and determining one or more search results of the search results interface based on the one or more badge clusters.

In some implementations, providing the search results interface based on the search query and the one or more badges can include determining the one or more badges are associated with the search query and obtaining product data associated with the particular product. The product data can include one or more links to one or more web resources associated with the particular product. The search results interface can include a product search result. The product search result can include data descriptive of the product and the one or more badges. In some implementations, the one or more machine-learned models can include a natural language processing model. The one or more particular uses can be determined based at least in part on sentiment analysis. The web information can include product descriptions and answers to frequently asked questions.

Another example aspect of the present disclosure is directed to a computer-implemented method. The method can include determining, by a computing system including one or more processors, one or more web resources associated with an object. The method can include processing, by the computing system, one or more content items of the one or more web resources with one or more machine-learned models to determine at least one of one or more advantages or one or more disadvantages associated with the object. The method can include generating, by the computing system, one or more badges based on the at least one of one or more advantages or one or more disadvantages associated with the object. In some implementations, the one or more badges can include a generated text label. The method can include obtaining, by the computing system, a search query from a user computing system. The method can include determining, by the computing system, at least one of the object or the one or more badges are associated with the search query and providing, by the computing system, a particular object search result for display in a search results interface. The particular object search result can include data descriptive of the object and a user interface element descriptive of the one or more badges.

In some implementations, determining, by the computing system, the at least one of the object or the one or more badges are associated with the search query can include processing, by the computing system, the search query with a search engine to determine a plurality of search results and determining, by the computing system, a set of badges associated with the plurality of search results. The set of badges can include the one or more badges. Determining, by the computing system, the at least one of the object or the one or more badges are associated with the search query can include providing, by the computing system, a set of particular search results in the search results interface based on the set of badges.

In some implementations, determining, by the computing system, the at least one of the object or the one or more badges are associated with the search query can include determining, by the computing system, a set of badges associated with the search query. The set of badges can include the one or more badges. Determining, by the computing system, the at least one of the object or the one or more badges are associated with the search query can include determining, by the computing system, a respective search result for each of the particular badges of the set of badges and providing, by the computing system, the set of respective search results in the search results interface based on the set of badges.

In some implementations, the method can include indexing, by the computing system, the one or more badges with data descriptive of the object. Determining the one or more web resources can include obtaining, by the computing system, data descriptive of the object; processing, by the computing system, the data descriptive of the object with a search engine to determine a set of object-specific search results; and selecting, by the computing system, one or more particular object-specific search results from the set of object-specific search results. In some implementations, the one or more web resources can include a web marketplace listing for the object.

Another example aspect of the present disclosure is directed to one or more non-transitory computer-readable media that collectively store instructions that, when executed by one or more computing devices, cause the one or more computing devices to perform operations. The operations can include obtaining a search query. The search query can be associated with a particular object type. The operations can include processing the search query to determine a plurality of badges associated with the search query. In some implementations, the plurality of badges can include a plurality of particular advantages associated with a plurality of different objects of the particular object type. The operations can include determining a subset of the plurality of badges to display. The operations can include obtaining a plurality of search results associated with the subset of the plurality of badges. The plurality of search results can include one or more respective search results for each particular badge of the subset of the plurality of badges. The operations can include providing a search results interface for display. In some implementations, the search results interface can include the plurality of search results. Each of the plurality of search results can be annotated with the particular badge associated with the respective search result.

In some implementations, the plurality of badges can be generated by processing a plurality of reviews for each of the plurality of different objects. The search results interface can include a first panel for the plurality of search results and a second panel for a model-generated response. The model-generated response can be generated by processing the search query with a language model to generate the model-generated response. The model-generated response can be responsive to the search query. The language model can include a text-to-text generative model.

In some implementations, the plurality of search results can include a plurality of product search results associated with a particular set of web resources. The search results interface can include a plurality of product search results, a plurality of general search results, and a natural language response. The natural language response can be generated with a machine-learned generative model. The plurality of general search results can be determined with a search engine.

Another example aspect of the present disclosure is directed to a computing system for providing search results based on machine-learned model determined badges. The system can include one or more processors and one or more non-transitory computer-readable media that collectively store instructions that, when executed by the one or more processors, cause the computing system to perform operations. The operations can include obtaining input data. The input data can include a search query. The search query can be associated with a subject of a search. The operations can include processing the search query to determine a plurality of preliminary search results. In some implementations, the plurality of preliminary search results can include a plurality of content items responsive to the search query. The operations can include processing at least a subset of the plurality of content items with a machine-learned model to determine a plurality of badges associated with the subject of the search. The plurality of badges can be associated with a plurality of terms determined to be associated with the subject. The operations can include determining a plurality of particular search results associated with the plurality of badges. In some implementations, each particular search result can be associated with a respective badge of the plurality of badges. The operations can include providing the plurality of particular search results for display with the plurality of badges.

In some implementations, the plurality of preliminary search results can include one or more web resources that includes user reviews. One or more of the plurality of badges can be determined based on a user-provided review. Each particular search result of the plurality of particular search results can be provided for display with a respective user interface element that is descriptive of the respective badge. In some implementations, the machine-learned model can include a natural language processing model. In some implementations, the operations can include processing the search query with a language model to generate a model-generated response, wherein the model-generated response is responsive to the search query and providing the model-generated response in a search results interface adjacent to the plurality of particular search results. The model-generated response can be determined by processing one or more of the plurality of preliminary search results with the language model.

In some implementations, the plurality of badges can be determined based at least in part on sentiment analysis performed by the machine-learned model. The plurality of badges can be determined based at least in part on a determined frequency of one or more terms. The subject can include a product type. The plurality of badges can be associated with qualities associated with different products of the product type. In some implementations, each particular search result of the plurality of particular search results can include a specific search result determined to be responsive to the search query and the respective badge.

Another example aspect of the present disclosure is directed to a computer-implemented method for machine-learned model determined category search. The method can include obtaining, by a computing system including one or more processors, input data. The input data can include a search query. In some implementations, the search query can be associated with a subject of a search. The method can include processing, by the computing system, the search query to determine a plurality of preliminary search results. The plurality of preliminary search results can include a plurality of content items responsive to the search query. The method can include processing, by the computing system, at least a subset of the plurality of content items with a machine-learned model to determine a plurality of badges associated with the subject of the search. The plurality of badges can be associated with a plurality of topics determined to be associated with the subject. The method can include determining, by the computing system, a plurality of particular search results associated with the plurality of badges. In some implementations, each particular search result can be associated with a respective badge of the plurality of badges. The method can include providing, by the computing system, the plurality of particular search results for display with the plurality of badges in a search results interface.

In some implementations, the search results interface can include a query input box, the plurality of particular search results with each of the respective badges of the plurality of badges, and a text-to-text generative model output. The text-to-text generative model output can be generated by processing the search query with a text-to-text generative model. The plurality of topics can be descriptive of one or more descriptors that differentiate web resources associated with the subject. In some implementations, the plurality of preliminary search results can include trusted web resources associated with web domains stored in a verified database.

In some implementations, the plurality of badges can be determined based on: determining a plurality of products associated the subject, determining a respective product description for each of the plurality of products, determining a plurality of differentiators associated with the plurality of products, and determining the plurality of badges based on the plurality of differentiators. The plurality of differentiators can be descriptive of qualities that differentiate a particular product from one or more other products that are associated with the subject.

Another example aspect of the present disclosure is directed to one or more non-transitory computer-readable media that collectively store instructions that, when executed by one or more computing devices, cause the one or more computing devices to perform operations. The operations can include obtaining input data. The input data can include a search query. In some implementations, the search query can be associated with a product type. The operations can include processing the input data to determine a plurality of preliminary search results. The plurality of preliminary search results can include a plurality of content items associated with the product type. The operations can include processing at least a subset of the plurality of content items with a machine-learned model to determine a plurality of badges associated with the subject of the search. In some implementations, the plurality of badges can be associated with a plurality of attributes determined to be associated with at least a subset of objects in the product type. The operations can include determining a plurality of particular search results associated with the plurality of badges. Each particular search result can be associated with a respective badge of the plurality of badges. The operations can include providing the plurality of particular search results for display with the plurality of badges.

In some implementations, the plurality of attributes can include one or more attributes associated with an effectiveness for a particular set of objects of the product type for a specific use. Each of the plurality of particular search results can be associated with a respective product of the product type. In some implementations, the operations can include obtaining a badge selection associated with a particular badge of the plurality of badges and providing a plurality of badge-specific search results associated with the particular badge.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example badge generation and search system according to example embodiments of the present disclosure.

FIG. 2 depicts a block diagram of an example search system according to example embodiments of the present disclosure.

FIG. 3 depicts a flow chart diagram of an example method to perform badge generation and search according to example embodiments of the present disclosure.

FIG. 4 depicts an illustration of an example search results interface with a knowledge panel according to example embodiments of the present disclosure.

FIG. 5 depicts an illustration of an example search results interface with adjacent panels for a model-generated response, badged results, and general results according to example embodiments of the present disclosure.

FIG. 6 depicts an illustration of an example search results interface with badge search result tiles according to example embodiments of the present disclosure.

FIG. 7 depicts a flow chart diagram of an example method to perform badge generation and search according to example embodiments of the present disclosure.

FIG. 8 depicts a flow chart diagram of an example method to perform badged search result searching according to example embodiments of the present disclosure.

FIG. 9A depicts a block diagram of an example computing system that performs badge generation and search according to example embodiments of the present disclosure.

FIG. 9B depicts a block diagram of an example computing system that performs badge generation and search according to example embodiments of the present disclosure.

FIG. 10 depicts a flow chart diagram of an example method to perform search-initiated badge generation according to example embodiments of the present disclosure.

FIG. 11 depicts a block diagram of an example badge generation and indexing system according to example embodiments of the present disclosure.

Reference numerals that are repeated across plural figures are intended to identify the same features in various implementations.

### DETAILED DESCRIPTION

Generally, the present disclosure is directed to generating badges for objects and/or environments based on processing web data with an artificial intelligence system. In particular, the systems and methods disclosed herein can leverage one or more machine-learned models to process web information associated with a subject to determine a particular use, advantage, and/or disadvantage associated with the subject. The particular use, advantage, and/or disadvantage can be utilized to generate a badge descriptive of the particular use, advantage, and/or disadvantage. The badge can then be utilized for ranking in returning search results and/or for annotating search results with an artificial intelligence determined label.

For example, web data (e.g., web information (e.g., user reviews)) associated with an object or environment can be obtained. The web data can be processed with one or more machine-learned models to determine attributes (e.g., a particular use, advantage, and/or disadvantage) associated with the particular object or environment. One or more badges can be generated based on the attributes, and the one or more badges can be indexed with data associated with the particular object (e.g., the one or more badges can be indexed with web resource information associated with the particular object or environment). The indexed badges may then be ranked in response to receiving a search query. The ranking of the indexed badges can determine which and/or how search results are provided to the user. The badges determined to be relevant to the search query may be provided for display with data associated with one or more respective web resources (e.g., respective search results).

The badges generated with and/or based on artificial intelligence can provide users with insight on qualities of different objects and/or environments that may traditionally be determined based off of tedious and time consuming manual review of various resources. The badges may additionally be utilized to provide a set of search results that are both responsive to the search query and diverse. The badges may be clustered to determine similar and/or redundant badges. The clusters can then be utilized to provide diverse and non-redundant results and/or may be utilized to provide search results and badges from a particular cluster based on a cluster being responsive to the search query.

Different objects and environments can have differing uses, pros, and/or cons. For example, different products may be better for particular locations and/or particular users. However, discerning which product excels for certain uses can be difficult when reviewing a traditional search results page.

The systems and methods disclosed herein can process web information including web reviews associated with a product with one or more machine-learned models to determine attributes associated with the product. One or more badges descriptive of the one or more attributes can then be generated and indexed with data associated with the product (e.g., one or more web resources associated with the product). The one or more badges may be provided as a user interface element when providing data associated with the product in order to provide an indicator to the user about the one or more determined attributes of the product.

The one or more badges can be associated with particular uses, particular advantages, and/or particular disadvantages. In some implementations, the one or more badges can be generated based on a determined difference between the particular object or environment when compared to other objects or environments in the same object class (or type) or environment class (or type). The one or more badges can be provided as text labels on a search results page and may be selectable to redirect to a search results page associated with a plurality of objects or environments determined to share that particular attribute.

In some implementations, the one or more badges can be associated with particular uses that may be associated with a where (e.g., a scenario for use), a why (e.g., a purpose for use), a when (e.g., a time for use), and/or a who (e.g., a type of user for the use). The use badges can be useful to indicate to users particular uses that an object may be specialized for and/or advantageous for when put to use.

For example, different kayaks may be better suited for different locations (e.g., lake (e.g., calm water, flat water, etc.), sea, whitewater, river, bays, waves, etc.), different purposes (e.g., fishing, recreational, touring, scuba diving, duck hunting, long trips, camping, expeditions, etc.), different times (e.g., winter, summer, fall, spring, day, night, etc.), and/or different users (e.g., children, beginners, bigger individuals, tandem, dogs, shorter individuals, solo use, heavier individuals, etc.). Additionally and/or alternatively, different dresses may be configured for different locations (e.g., school, work, going out, party, formal, beach, etc.), different purposes (e.g., casual use (e.g., every occasion), holidays, traveling, special occasions, prom, graduation, exercising, date night, etc.), different times (e.g., hot season, cold season, specific holidays, winter, summer, fall, spring, day, night, etc.), and/or different users (e.g., wedding guests, maternity, different body shapes, children, babies, young adults, bigger individuals, dogs, shorter individuals, heavier individuals, nurses, lawyers, doctors, mechanics, etc.). In some implementations, user reviews may be processed to determine different baby strollers may be associated with use in different locations (e.g., car seat, all terrain, beach, for amusement park, travel, jogging, hiking, shopping, city use, airplane, etc.), for different purposes (e.g., day-to-day use, active, etc.), for different times (e.g., hot season, cold season, winter, summer, fall, spring, day, night, etc.), and/or for different users (e.g., for newborns, double, for tall parents, triple, toddlers, for bigger children, short individuals, grandparents, etc.).

Additionally and/or alternatively, different downhill skis may be more advantageous for different locations (e.g., piste (e.g., resort), backcountry (e.g., off piste), mogul, park, icy condition, crud, big mountain, steep, forests, tight terrain, etc.), different purposes (e.g., powder, all mountain, carving, frecride (e.g., touring), racing (e.g., high speed), quick turns, etc.), different times (e.g., early season, late season, winter, after snow, after freeze, summer, fall, spring, day, night, etc.), and/or different users (e.g., beginners, casual skiers, competitive skiers, professionals, children, larger individuals, smaller individuals, stiff users, agile users, etc.). In some implementations, user reviews may be processed to determine different vacuums may be associated with use in different locations (e.g., car, recreational vehicle, stairs, hardwood floor, tile floor, mattress, garage, carpet, fireplace, small places, furniture, sofa, etc.), for different purposes (e.g., pet hair, ash, bugs, computer, long hair, horses, cleaning stains, etc.), for different times (e.g., pollen season, winter, summer, fall, spring, day, night, etc.), and/or for different users (e.g., shorter individuals, taller individuals, children, individuals with kids, individuals with allergies, etc.).

The systems and methods of the present disclosure provide a number of technical effects and benefits. As one example, the systems and methods can provide a search system that can identify and indicate search results that are associated with particular uses and/or advantages. For example, the systems and methods disclosed herein can leverage one or more machine-learned models to determine particular uses and/or particular advantages associated with an object and/or environment, and the determined particular uses and/or particular advantages can then be utilized to provide intuitive and/or tailored search results to a user.

Another technical benefit of the systems and methods of the present disclosure is the ability to leverage artificial intelligence generated badges to provide diverse and labeled search results. In particular, the badges can be generated and stored based on processing web information (e.g., web reviews) associated with a particular object and/or environment. A search query may then be received, which may cause the search system to rank the various indexed badges. A set of badges and associated search results can be provided to the user in a search results interface to provide labeled search results that are responsive to the search query.

Another example of technical effect and benefit relates to improved computational efficiency and improvements in the functioning of a computing system. For example, the systems and methods disclosed herein can leverage badge embeddings to determine badge clusters. The badge clusters can be descriptive of a group of badges that are associated with the same or similar attribute, use, advantage, and/or disadvantage. The systems and methods can then utilize badge clusters to ensure redundant badges are not provided to the user, which can therefore limit the computational cost of generating and providing search results as the systems and methods limit retrieval to only a subset of each cluster determined to have an association with the search query.

With reference now to the Figures, example embodiments of the present disclosure will be discussed in further detail.

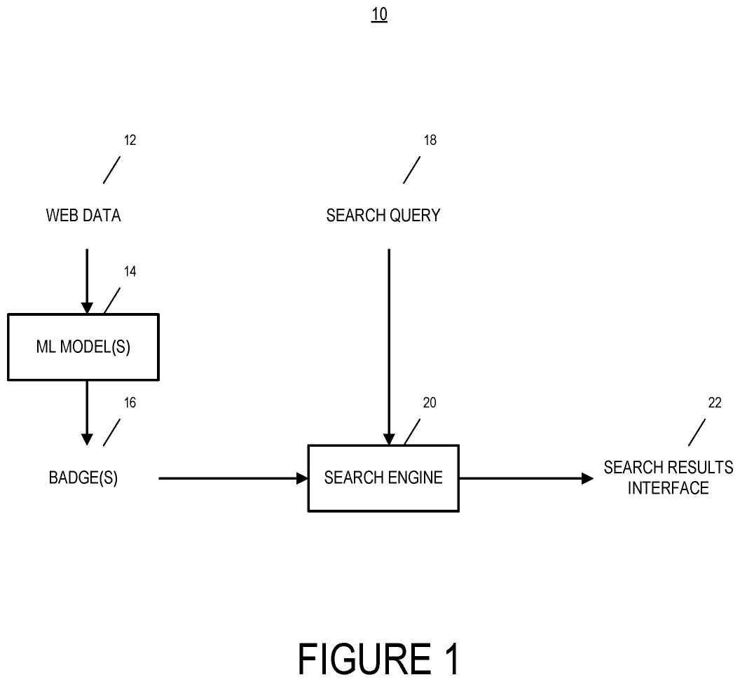

FIG. 1 depicts a block diagram of an example badge generation and search system 10 according to example embodiments of the present disclosure. In some implementations, the badge generation and search system 10 is configured to receive, and/or obtain, web data 12 descriptive of web information associated with a particular object (e.g., a particular product) or environment and, as a result of receipt of the web data 12, generate, determine, and/or provide badges 16 that are descriptive of determined attributes (or qualities) of the particular object or environment. Thus, in some implementations, the artificial intelligence generated badge search system 10 can include one or more machine-learned models 14 that are operable to determine particular uses, advantages, and/or disadvantages associated with the particular object or environment.

In particular, web data 12 associated with a subject (e.g., a particular object or environment) can be obtained. The web data 12 can include web information associated with the subject. The web information can include a marketplace listing, description(s), user reviews, frequently asked questions, marketing information, and/or social media posts. The web data may be obtained by determining web resources associated with the subject (e.g., top search results determined when searching the subject with a search engine).

The web data 12 can be processed with one or more machine-learned models 14 to generate one or more badges 16. The one or more machine-learned models 14 can be trained and/or configured for natural language processing, sequence determination, sentiment analysis, semantic analysis, and/or one or more classifications. The one or more machine-learned models 14 can be trained to identify attributes (e.g., particular uses, advantages, and/or disadvantages) associated with the subject. The one or more machine-learned models 14 can include a generative model (e.g., a generative language model (e.g., a large language model, which may include an autoregressive language model). The one or more badges 16 can be descriptive of the identified attribute(s). The one or more badges 16 may be stored (and/or indexed) with data descriptive of the subject (e.g., one or more web resources, text data, and/or embedding data).

A search query 18 (e.g., a text query, an image query, and/or a multimodal query) may be obtained. The search query 18 may include one or more search terms. The one or more search terms can be associated with the subject (e.g., terms descriptive of the subject, the use for the subject, and/or an object type associated with the subject).

The search query 18 can be processed with a search engine 20 to determine the one or more badges 16 are associated with the search query 18. Based on the one or more badges 16 being associated with the search query 18, one or more search results associated with the subject and/or the badges 16 may be obtained and provided for display via a search results interface 22.

The search results interface 22 may include badged search results with one or more user interface elements descriptive of the one or more respective badges. In some implementations, the search results interface may include a model-generated response, a knowledge panel, badged search result(s), general search result(s), and/or search refinement suggestions. In some implementations, the badges 16 may be utilized as section headings for one or more search results. For example, a set of products (associated with a set of search results) may share a first badge. The set of products may then be provided for display under and/or in a panel header that includes a badge description (or title).

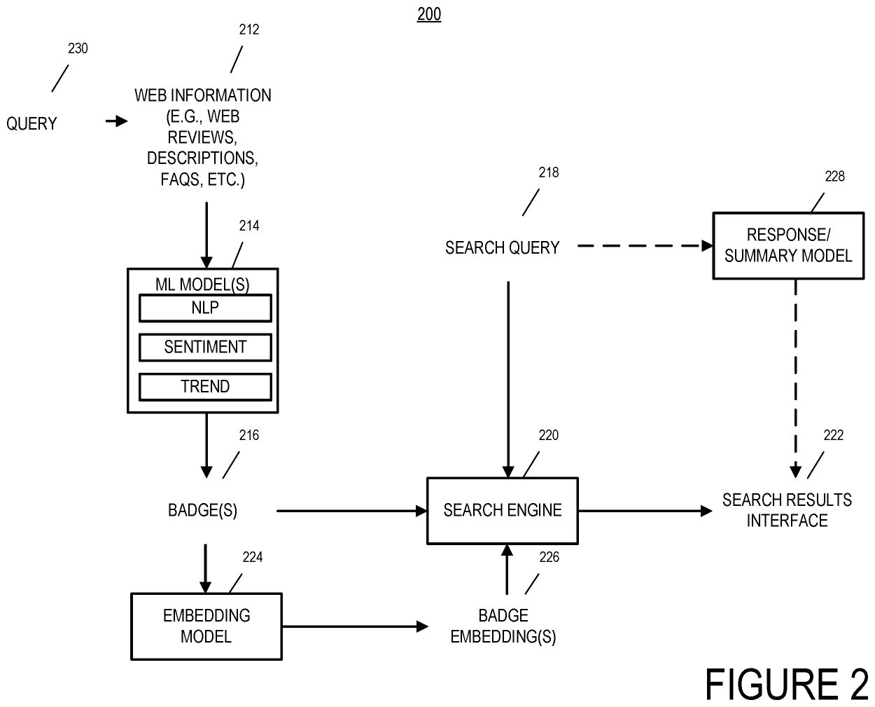

FIG. 2 depicts a block diagram of an example search system 200 according to example embodiments of the present disclosure. The search system 200 is similar to the badge generation and search system 10 of FIG. 1 except that search system 200 further includes an embedding model 224 to generate badge embedding(s) 226.

In particular, web data 212 associated with a subject (e.g., a particular object or environment) can be obtained. The web data 212 can include web information associated with the subject. The web information can include a marketplace listing, description(s), user reviews, frequently asked questions, marketing information, and/or social media posts. The web data may be obtained by determining web resources associated with the subject (e.g., top search results determined when searching the subject with a search engine). For example, a query 230 descriptive of the subject can be provided to a search engine 220 to determine a plurality of preliminary search results. The plurality of preliminary search results may be processed to obtain the web data 212. In some implementations, a subset of the content associated with the plurality of preliminary search results can be extracted to generate the web data 212.

The web data 212 can be processed with one or more machine-learned models 214 (e.g., one or more generative models) to generate one or more badges 216. The one or more machine-learned models 214 can include one or more natural language processing models (e.g., a language prediction model, a summarization model, one or more sentiment analysis models, and/or one or more trend prediction/analysis models (e.g., one or more sequence prediction models)). The one or more machine-learned models 214 can be trained and/or configured for natural language processing, sequence determination, sentiment analysis, semantic analysis, and/or one or more classifications. The one or more machine-learned models 214 can be trained to identify attributes (e.g., particular uses, advantages, and/or disadvantages) associated with the subject. The one or more badges 16 can be descriptive of the identified attribute(s). The one or more badges 16 may be stored (and/or indexed) with data descriptive of the subject (e.g., one or more web resources, text data, and/or embedding data).

In some implementations, the one or more badges 216 can be processed with an embedding model 224 to generate one or more badge embeddings 226. The one or more badge embeddings 226 can be descriptive of a topic relationship for the particular badge. The badge embeddings 226 can be utilized to determine similar embeddings and/or to generate badge clusters for search. The embedding model 224 may be trained to generate similar embeddings for badges, search results, and/or queries associated with a similar topic.

A search query 218 (e.g., a text query, an image query, and/or a multimodal query) may be obtained. The search query 218 may include one or more search terms. The one or more search terms can be associated with the subject (e.g., terms descriptive of the subject, the use for the subject, and/or an object type associated with the subject).

The search query 218 can be processed with a search engine 220 to determine the one or more badges 216 are associated with the search query 218. Based on the one or more badges 16 being associated with the search query 218, one or more search results associated with the subject and/or the badges 216 may be obtained and provided for display via a search results interface 222. In some implementations, the one or more search results may be determined based at least in part on the one or more badge embeddings 226 (e.g., the search query may be embedded and embedding neighbors (e.g., badge embeddings and/or search result embeddings) for the generated query embedding may be utilized to determine one or more associated badges and/or one or more associated search results).

The search results interface 222 may include badged search results with one or more user interface elements descriptive of the one or more respective badges. In some implementations, the search results interface may include a model-generated response, a knowledge panel, badged search result(s), general search result(s), and/or search refinement suggestions.

For example, the search results interface 222 may include a model-generated response that may be generated by processing the search query 218 and/or one or more preliminary search results with a generative model 228 (e.g., a response/summary natural language processing model). The generative model 228 may include a text-to-text generative model, an image-to-text generative model, an image generation model, and/or one or more other models.

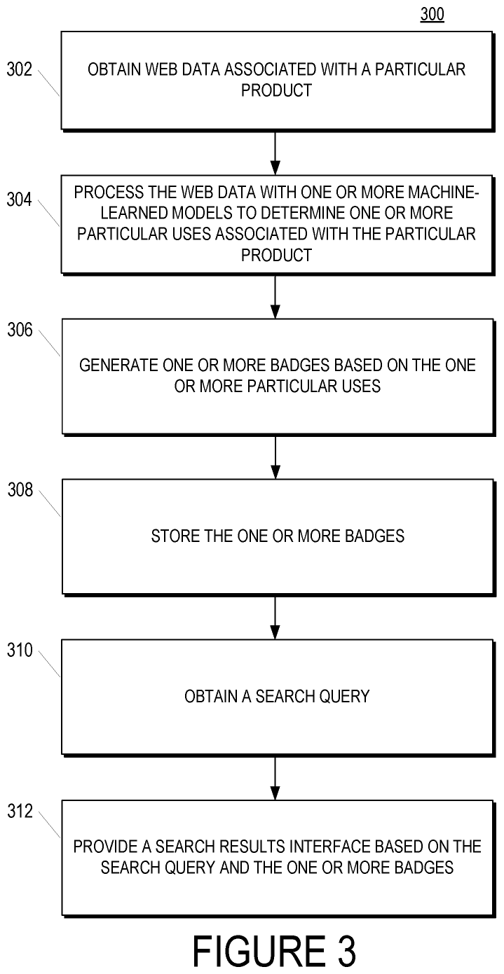

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain web data associated with a particular product. The web data can include web information associated with the particular product. The web data can include user reviews of the particular product. In some implementations, the web information can include product descriptions and answers to frequently asked questions.

At 304, the computing system can process the web data with one or more machine-learned models to determine one or more particular uses associated with the particular product. The one or more particular uses can be determined based on the web information. In some implementations, the one or more particular uses can be determined based on a frequency of a term in the web information, sentiment analysis, and semantic understanding. The one or more particular uses can be associated with at least one of a scenario for using the particular product, a purpose for using the particular product, a time for using the particular product, or a type of user that uses the product. In some implementations, the one or more machine-learned models can include a natural language processing model. The one or more particular uses can be determined based at least in part on sentiment analysis.

At 306, the computing system can generate one or more badges based on the one or more particular uses. The badge can be descriptive of the one or more particular uses. The one or more particular uses can be associated with a where (e.g., a scenario), a why (e.g., a purpose), a when (e.g., a time), and/or a who (e.g., a type of customer). The particular uses can be utilized as badges for the product. In some implementations, the badge(s) may be processed with an embedding model to generate one or more badge embeddings in an embedding space. The badge embedding(s) can be utilized to determine badge clusters (e.g., a group of badges directed to similar and/or identical uses). The badge clusters can be utilized during search. For example, the search system may only surface one or a small subset of the badges in a particular cluster in order to limit redundancy. Alternatively and/or additionally, the search system may rank based on clusters, and/or may provide badges based on a cluster family member being highly ranked. In some implementations, the badge embedding may be utilized for determining when a badge and a respective search result may be surfaced in a search results interface.

At 308, the computing system can store the one or more badges. The one or more badges can be stored with data descriptive of an association with the particular product. In some implementations, the one or more badges can be stored in a badge database and may be stored with one or more links to one or more web resources associated with the subject of the badge.

At 310, the computing system can obtain a search query. The search query can be associated with a product type. In some implementations, the particular product can be of the product type. The search query can include a text query, an image query, a multimodal query, and/or another type of query. The one or more badges may be generated at a first time, and the search query may be obtained at a second time. The second time may be after the first time.

At 312, the computing system can provide a search results interface based on the search query and the one or more badges. Providing the search results interface based on the search query and the one or more badges can include determining the one or more badges are associated with the search query and obtaining product data associated with the particular product. The product data can include one or more links to one or more web resources associated with the particular product. The search results interface can include a product search result. The product search result can include data descriptive of the product and the one or more badges.

In some implementations, the computing system can process the one or more badges with an embedding model to generate one or more respective badge embeddings in an embedding space and determine a plurality of search results to display in the search results interface based on the one or more badge embeddings. Determining the plurality of search results can include processing the search query with the embedding model to generate a query embedding, determining the query embedding is associated with the badge embedding, and providing a product search result descriptive of the particular product in the search results interface.

In some implementations, the computing system can process a plurality of other badges associated with a plurality of other products with the embedding model to generate a plurality of other badge embeddings, determine one or more badge clusters based on one or more badge embeddings and the plurality of other badge embeddings, and determine one or more search results of the search results interface based on the one or more badge clusters.

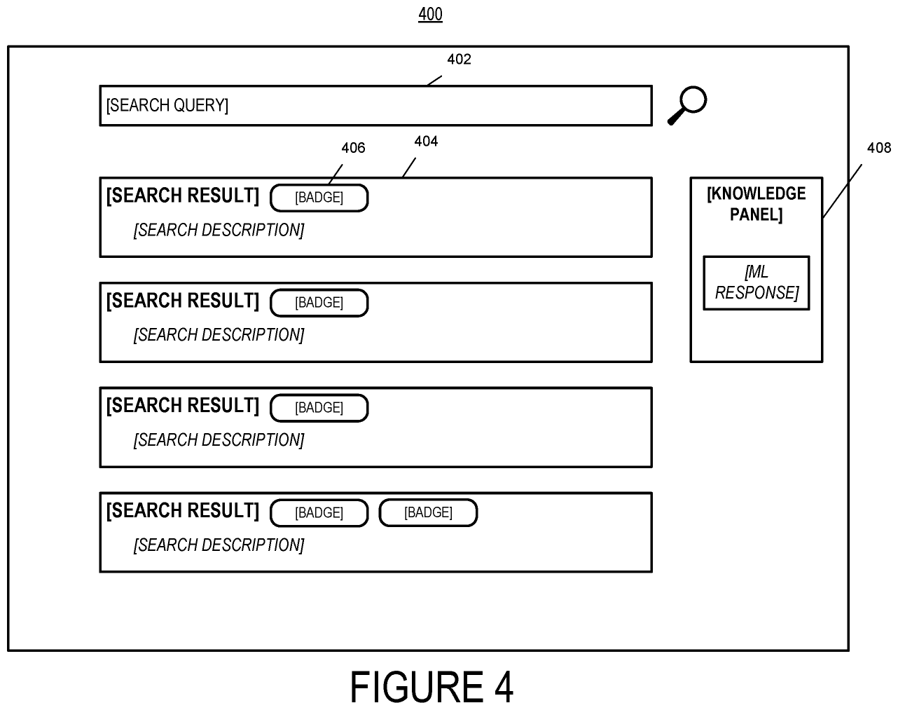

FIG. 4 depicts an illustration of an example search results interface 400 with a knowledge panel according to example embodiments of the present disclosure. In particular, the search results interface 400 can include a search query input box 402, a plurality of search results 404 with respective badge(s) 406, and/or a knowledge panel 408.

The search query input box 402 can be configured to receive query inputs from a user. The search query input box 402 can receive a freeform text input, a selection input, a data file input, and/or one or more other inputs (e.g., a multimodal input).

The plurality of search results 404 may be determined by processing a query input into the search query input box 402. The plurality of search results 404 may be determined based on a keyword search, an embedding search, badge ranking and search, badge cluster ranking, and/or feature searching. The plurality of search results 404 may be provided for display with one or more badge indicators 406 descriptive of one or more respective badges for the particular search result. In some implementations, each search result of the plurality of search results 404 may include a search result title, a search result description, a badge indicator 406, and/or one or more media content items (e.g., an image thumbnail).

The knowledge panel 408 can include a model-generated response that may be generated by processing a search query and/or one or more datasets with a generative model (e.g., a generative language model (e.g., a large language model)). In some implementations, the knowledge panel 408 can include one or more media content items (e.g., one or more images), a topic summary, and/or other data obtained from a knowledge database. The data provided in the knowledge panel 408 may be associated with a topic determined to be responsive to the search query.

The plurality of search results 404 may be adjacent to the knowledge panel 408 and/or may be in separate panels.

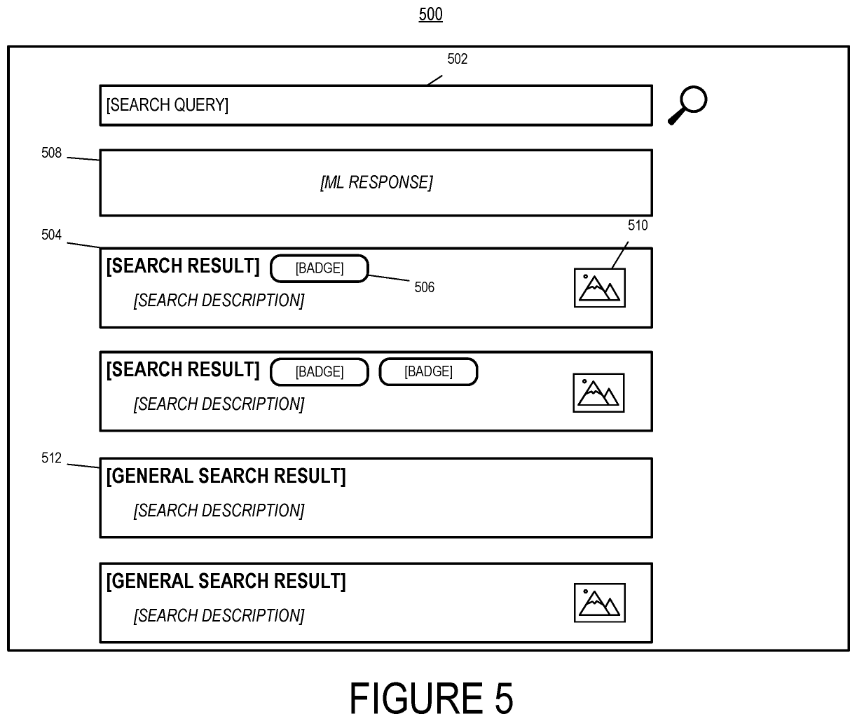

FIG. 5 depicts an illustration of an example search results interface 500 with adjacent panels for a model-generated response, badged results, and general results according to example embodiments of the present disclosure. In particular, the search results interface 500 can include a search query input box 502, a plurality of badged search results 504, a plurality of general search results 512, and/or a model-generated response 508. The model-generated response 508, the plurality of badged search results 504, and/or the plurality of general search results 512 may be adjacent to one another and/or may be in separate panels.

The search query input box 502 can be configured to receive query inputs from a user. The search query input box 502 can receive a freeform text input, a selection input, a data file input, and/or one or more other inputs (e.g., a multimodal input).

The plurality of badged search results 504 may be determined by processing a query input into the search query input box 502. The plurality of badged search results 504 may be determined based on a keyword search, an embedding search, badge ranking and search, badge cluster ranking, and/or feature searching. The plurality of badged search results 504 may be provided for display with one or more badge indicators 506 descriptive of one or more respective badges for the particular search result. In some implementations, each search result of the plurality of search results 504 may include a search result title, a search result description, a badge indicator 506, and/or one or more media content items 510 (e.g., an image thumbnail).

The model-generated response 508 may be generated by processing a search query and/or one or more datasets with a generative model. In some implementations, the model-generated response 508 can include one or more media content items (e.g., one or more images), a topic summary, and/or other response data.

The plurality of general search results 512 can include general search results that may not include indexed badges. The plurality of general search results 512 may be determined based on a text search, a feature search, and/or an embedding search.

The plurality of badged search results 504 may be a product search result with indexed badges. Each of the plurality of badged search results 504 can be associated with one or more actions (e.g., a purchase action, a reservation action, and/or one or more other actions).

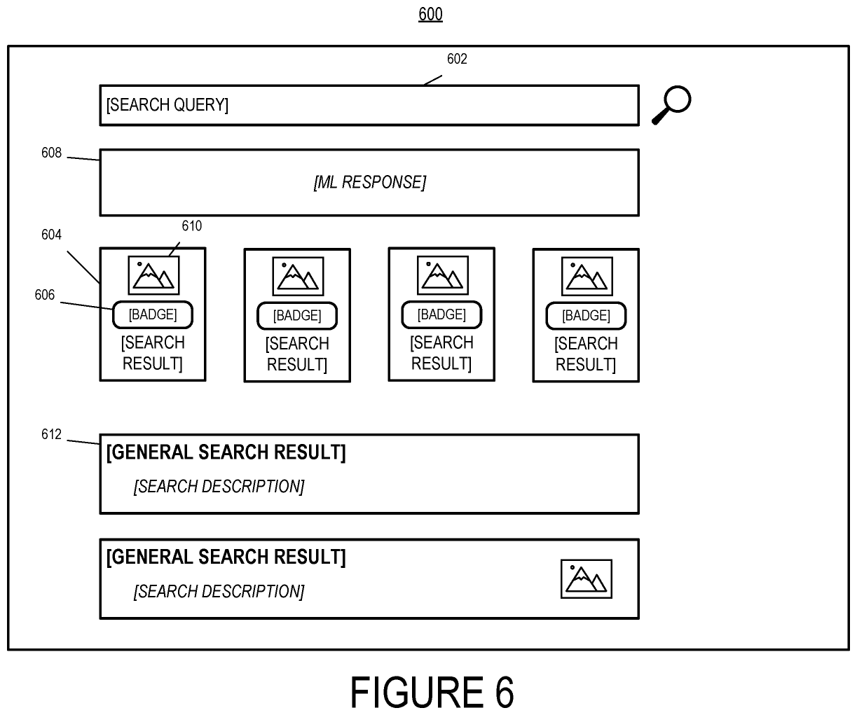

FIG. 6 depicts an illustration of an example search results interface 600 with badge search result tiles according to example embodiments of the present disclosure. In particular, the search results interface 600 of FIG. 6 can include similar display data types as the search results interface 500 of FIG. 5; however, the search results interface 600 of FIG. 6 may include different search result formats for the plurality of badged search results 604 and the plurality of general search results 612.

For example, the search results interface 600 can include a search query input box 602, a plurality of badged search results 604 in a tile format, a plurality of general search results 612, and/or a model-generated response 608. The model-generated response 608, the plurality of badged search results 604, and/or the plurality of general search results 612 may be adjacent to one another and/or may be in separate panels.

The search query input box 602 can be configured to receive query inputs from a user. The search query input box 602 can receive a freeform text input, a selection input, a data file input, and/or one or more other inputs (e.g., a multimodal input).

The plurality of badged search results 604 may be determined by processing a query input into the search query input box 602. The plurality of badged search results 604 can be provided as tiles in a horizontal line and may be provided in a carousel interface. The plurality of badged search results 604 may be determined based on a keyword search, an embedding search, badge ranking and search, badge cluster ranking, and/or feature searching. The plurality of badged search results 604 may be provided for display with one or more badge indicators 606 descriptive of one or more respective badges for the particular search result. In some implementations, each search result of the plurality of search results 604 may include a search result title, a badge indicator 606, and/or one or more media content items 610 (e.g., an image thumbnail and/or a video thumbnail).

The model-generated response 608 may be generated by processing a search query and/or one or more datasets with a generative model. In some implementations, the model-generated response 608 can include one or more media content items (e.g., one or more images), a topic summary, and/or other response data.

The plurality of general search results 612 can include general search results that may not include indexed badges. The plurality of general search results 612 may be determined based on a text search, a feature search, and/or an embedding search.

The plurality of badged search results 604 may be a product search result with indexed badges. Each of the plurality of badged search results 604 can be associated with one or more actions (e.g., a purchase action, a reservation action, and/or one or more other actions).

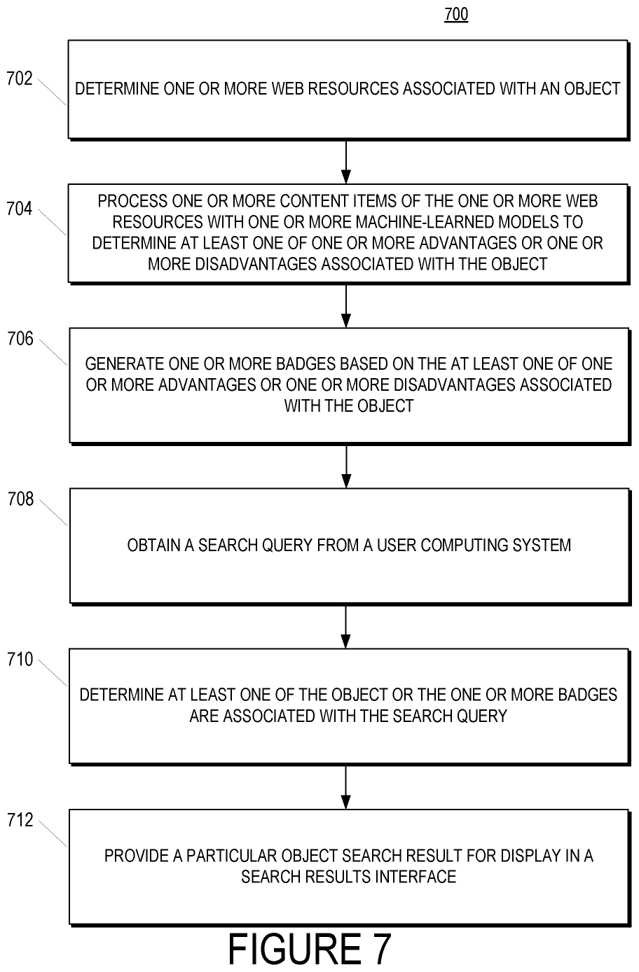

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can determine one or more web resources associated with an object. The one or more web resources can include a web marketplace listing for the object. The one or more web resources can include review databases that store and/or provide user reviews for one or more products and/or places. In some implementations, the one or more web resources can include a product fact sheet, a marketplace listing, a review platform, a social media platform, an encyclopedia resource, and/or another accessible web resource.

In some implementations, determining the one or more web resources can include obtaining data descriptive of the object, processing the data descriptive of the object with a search engine to determine a set of object-specific search results, and selecting one or more particular object-specific search results from the set of object-specific search results.

At 704, the computing system can process one or more content items of the one or more web resources with one or more machine-learned models to determine at least one of one or more advantages or one or more disadvantages associated with the object. The one or more advantages and/or the one or more disadvantages may be determined by processing, parsing, and/or interpreting user reviews associated with the object. The processing and parsing may include natural language processing, sentiment analysis, and/or semantic analysis. The determination may include the interpolation of trends among a plurality of reviews.

At 706, the computing system can generate one or more badges based on the at least one of one or more advantages or one or more disadvantages associated with the object. The one or more badges can include a generated text label. The badges may be embedded such that similar advantages have similar badge embeddings and can be clustered to be later used for determining similar badges and/or similar search results.

In some implementations, the computing system can index the one or more badges with data descriptive of the object.

At 708, the computing system can obtain a search query from a user computing system. The search query may be obtained from a user computing system that may be unassociated with the one or more web resources. The search query can include one or more search terms associated with an object type and/or a topic that may be associated with the object.

At 710, the computing system can determine at least one of the object or the one or more badges are associated with the search query. For example, badges may be ranked based on the received search query, which can then be utilized to determine which search results are to be provided. Alternatively and/or additionally, a plurality of search results can be determined based on a search query, and based on the search results, the badges and their respective search results can be determined and provided.

In some implementations, determining the at least one of the object or the one or more badges are associated with the search query can include processing the search query with a search engine to determine a plurality of search results, determining a set of badges associated with the plurality of search results, and providing a set of particular search results in the search results interface based on the set of badges. The set of badges can include the one or more badges.

Alternatively and/or additionally, determining the at least one of the object or the one or more badges are associated with the search query can include determining a set of badges associated with the search query, determining a respective search result for each of the particular badges of the set of badges, and providing the set of respective search results in the search results interface based on the set of badges. The set of badges can include the one or more badges.

At 712, the computing system can provide a particular object search result for display in a search results interface. The particular object search result can include data descriptive of the object and a user interface element descriptive of the one or more badges.

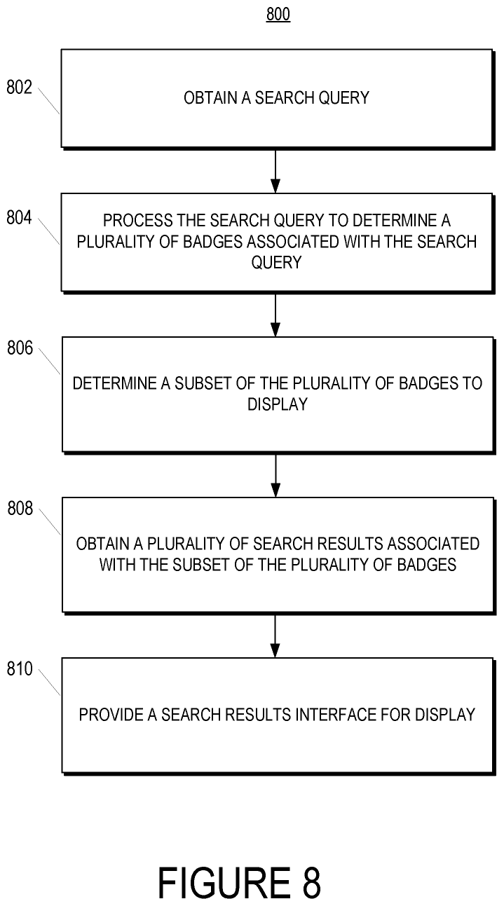

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a search query. The search query can be associated with a particular object type. The search query can include text data, image data, latent encoding data, audio data, and/or multimodal data. The search query can be manually generated and/or automatically generated based on one or more user interactions. The search query may be automatically generated to determine search results to suggest to a user. Alternatively and/or additionally, the search query can include a model-generated query that may be generated based on a user providing a prompt to a generative model.

At 804, the computing system can process the search query to determine a plurality of badges associated with the search query. The plurality of badges can include a plurality of particular advantages associated with a plurality of different objects of the particular object type. In some implementations, the plurality of badges can be generated by processing a plurality of reviews for each of the plurality of different objects.

At 806, the computing system can determine a subset of the plurality of badges to display. The determination can be based on a badge ranking, which may include text based ranking, embedding based ranking, node based ranking, and/or machine-learned model based ranking. In some implementations, a plurality of badge clusters may be ranked, and the badges associated with the most relevant badge clusters can then be ranked. The subset may include a limited number of badges (e.g., one or two) from a badge cluster to allow for a diverse and non-redundant display of badges and search results.

At 808, the computing system can obtain a plurality of search results associated with the subset of the plurality of badges. The plurality of search results can include one or more respective search results for each particular badge of the subset of the plurality of badges.

At 810, the computing system can provide a search results interface for display. The search results interface can include the plurality of search results. Each of the plurality of search results can be annotated with the particular badge associated with the respective search result. In some implementations, the search results interface can include a first panel for the plurality of search results and a second panel for a model-generated response. The model-generated response can be generated by processing the search query with a language model to generate the model-generated response. The model-generated response can be responsive to the search query. The language model can include a text-to-text generative model. Alternatively and/or additionally, the model-generated response can be generated by processing one or more search results (e.g., the content of one or more web resources) associated with the search query to generate a summarization response. In some implementations, the natural language response may be determined based on model inference with the language model without further input. The badged search results may be associated with products. Additionally and/or alternatively, the badged search results may be associated with a particular action (e.g., a purchase action). Each of the badges can be associated with a particular use associated with the particular product.

In some implementations, the plurality of search results can include a plurality of product search results associated with a particular set of web resources. The search results interface can include a plurality of product search results, a plurality of general search results, and a natural language response. The natural language response can be generated with a machine-learned generative model. In some implementations, the plurality of general search results can be determined with a search engine.

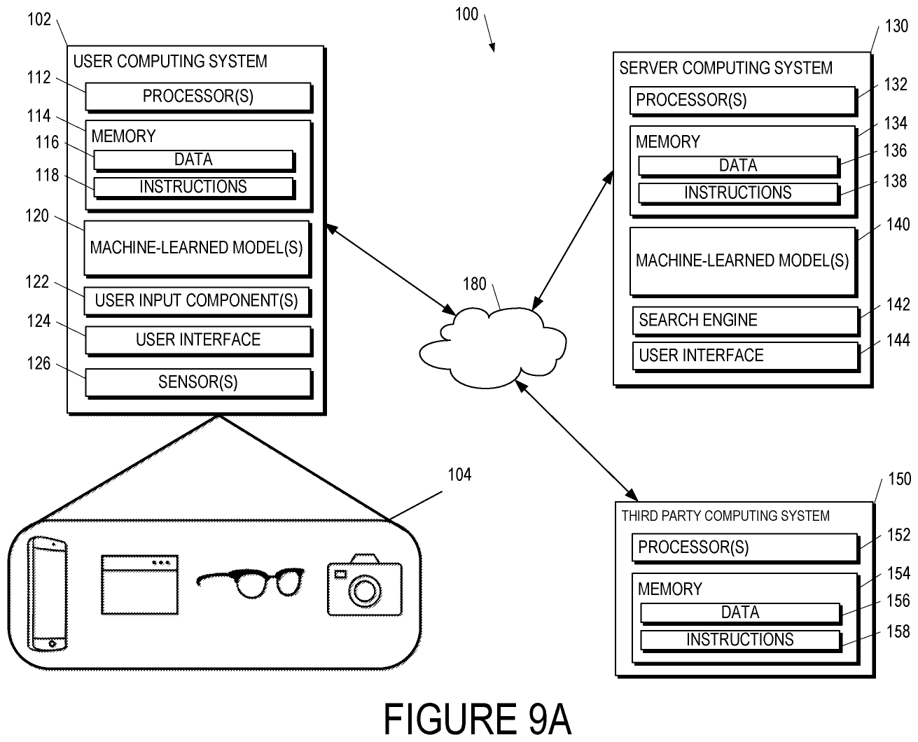

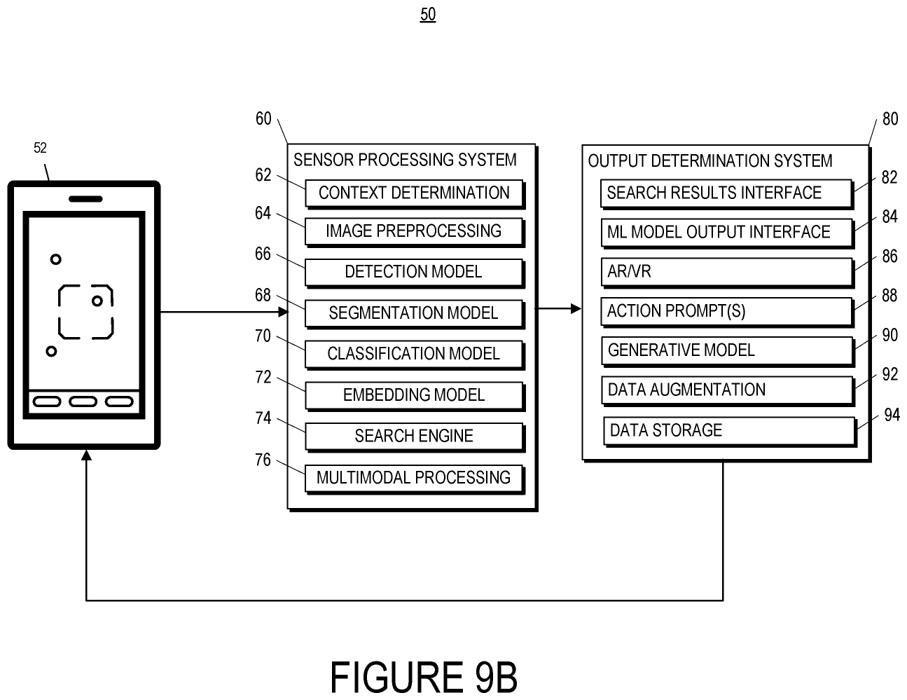

FIG. 9A depicts a block diagram of an example computing system 100 that performs badge generation and search according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV: 2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

In some implementations, the one or more machine-learned models 120 can process web information (e.g., user reviews, descriptions, and/or other content) to determine one or more uses, one or more advantages, and/or one or more disadvantages associated with a particular object or environment. The determined one or more uses, one or more advantages, and/or one or more disadvantages can then be utilized to generate one or more badges for the respective object or environment.

In some implementations, the one or more machine-learned models 120 can include one or more embedding models. The one or more embedding models can process the one or more badges to generate one or more badge embeddings in an embedding space. The one or more badge embeddings can be utilized for embedding based searching and/or for determining badge relationships (e.g., similar embeddings). For example, badge clusters can be determined based on the badge embeddings. The badge clusters can be descriptive of badges associated with a similar topic.

The embedding model may be trained on question and answer training example sets. For example, the embedding model may be trained to process a question example to generate a question embedding. The question embedding may be compared against one or more other embeddings associated with questions with similar answers. One or more parameters of the embedding model may be adjusted based on a gradient descent output of a loss function that evaluates the differences between the embeddings. The embedding model may be trained to output similar embeddings for questions with similar answers and differing embeddings for questions with differing answers. In some implementations, the embedding model may be trained on other training datasets.

In some implementations, the one or more machine-learned models 120 can include a generative model that can be trained to process a search query and/or one or more content items to generate a model-generated response. The model-generated response can include a predicted natural language response and/or a summarization response. The generative model can include a text generation model (e.g., a text-to-text autoregressive language model), an image generation model (e.g., a text-to-image diffusion model), and/or one or more other generative models.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 9B depicts a block diagram of an example computing system 50 that performs badge generation and search according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model. The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv: 2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

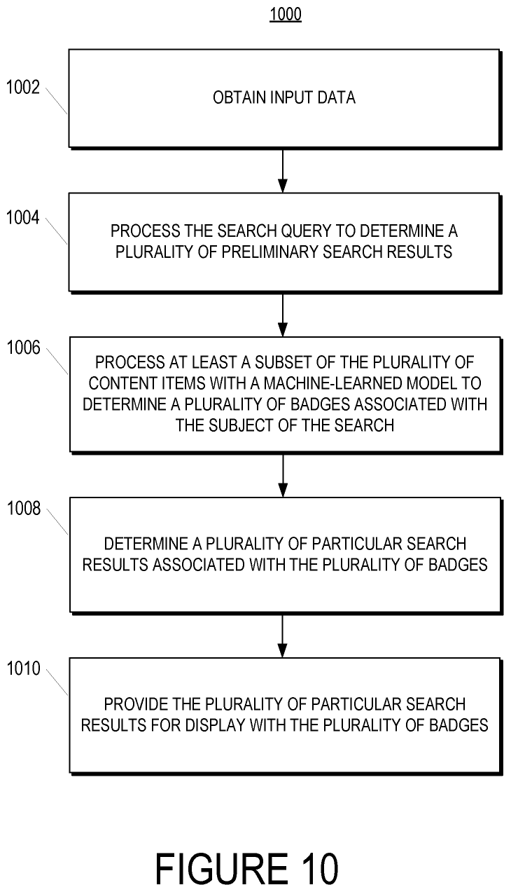

FIG. 10 depicts a flow chart diagram of an example method to perform according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a computing system can obtain input data. The input data can include a search query. In some implementations, the search query can be associated with a subject of a search. The search query can be associated with a product type.

At 1004, the computing system can process the search query to determine a plurality of preliminary search results. The plurality of preliminary search results can include a plurality of content items responsive to the search query. In some implementations, the plurality of preliminary search results can include a plurality of content items associated with the product type. The plurality of preliminary search results can include one or more web resources that include user reviews. The plurality of preliminary search results can include trusted web resources associated with web domains stored in a verified database.

At 1006, the computing system can process at least a subset of the plurality of content items with a machine-learned model to determine a plurality of badges associated with the subject of the search. The plurality of badges can be associated with a plurality of terms determined to be associated with the subject. In some implementations, the plurality of badges can be associated with a plurality of topics determined to be associated with the subject. The plurality of badges can be associated with a plurality of attributes determined to be associated with at least a subset of objects in the product type. The plurality of attributes can include one or more attributes associated with an effectiveness for a particular set of objects of the product type for a specific use. In some implementations, one or more of the plurality of badges can be determined based on a user-provided review. The machine-learned model can include a natural language processing model. The plurality of badges can be determined based at least in part on sentiment analysis performed by the machine-learned model. In some implementations, the plurality of badges can be determined based at least in part on a determined frequency of one or more terms. The badge determination can be based on a frequency of a term being used, sentiment analysis, semantic understanding, and/or context data. The subject can include a product type. The plurality of badges can be associated with qualities associated with different products of the product type. The plurality of topics can be descriptive of one or more descriptors that differentiate web resources associated with the subject.

In some implementations, the plurality of badges can be determined based on: determining a plurality of products associated the subject, determining a respective product description for each of the plurality of products, determining a plurality of differentiators associated with the plurality of products, and determining the plurality of badges based on the plurality of differentiators. The plurality of differentiators can be descriptive of qualities that differentiate a particular product from one or more other products that are associated with the subject.

At 1008, the computing system can determine a plurality of particular search results associated with the plurality of badges. Each particular search result can be associated with a respective badge of the plurality of badges. In some implementations, each particular search result of the plurality of particular search results can be provided for display with a respective user interface element that is descriptive of the respective badge. Each particular search result of the plurality of particular search results can include a specific search result determined to be responsive to the search query and the respective badge. Each of the plurality of particular search results can be associated with a respective product of the product type.

At 1010, the computing system can provide the plurality of particular search results for display with the plurality of badges. The plurality of particular search results can be provided for display in a search results interface. The search results interface can include a query input box, the plurality of particular search results with each of the respective badges of the plurality of badges, and a text-to-text generative model output. The text-to-text generative model output can be generated by processing the search query with a text-to-text generative model.

In some implementations, the computing system can process the search query with a language model to generate a model-generated response. The model-generated response can be responsive to the search query. The computing system can provide the model-generated response in a search results interface adjacent to the plurality of particular search results. The model-generated response can be determined by processing one or more of the plurality of preliminary search results with the language model.

Additionally and/or alternatively, the computing system can obtain a badge selection associated with a particular badge of the plurality of badges and provide a plurality of badge-specific search results associated with the particular badge.

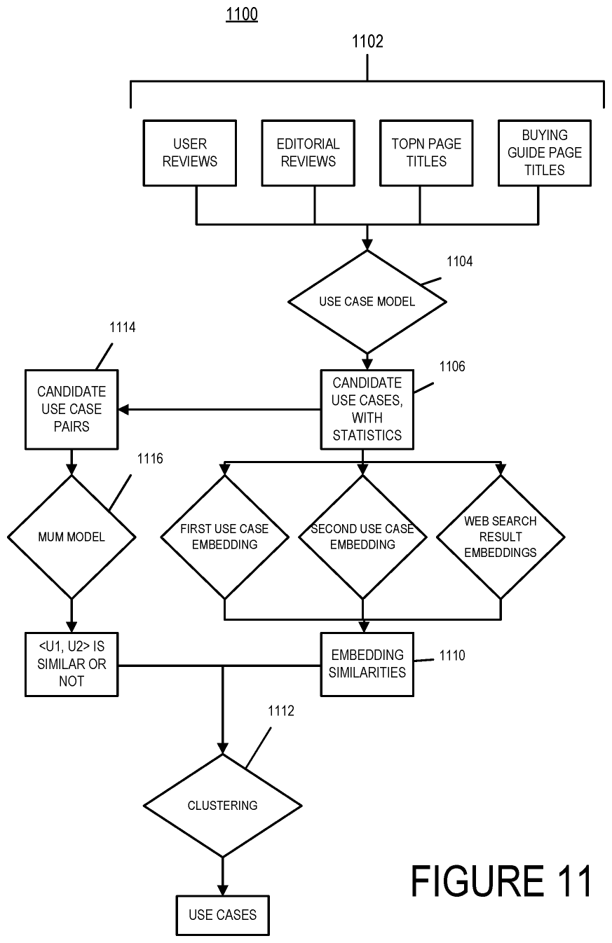

FIG. 11 depicts a block diagram of an example badge generation and indexing system 1100 according to example embodiments of the present disclosure. In particular, the badge generation and indexing system 1100 can include obtaining and/or determining web information 1102 to process. The web information 102 can include user reviews, editorial reviews, TopN page titles, and/or buying guide page titles.

The web information 1102 can be processed with one or more use case models 1104 to determine one or more candidate use cases 1106 associated with the subject of the web information 1102. The one or more use case models 1104 can output the one or more candidate use cases 1104 with determined statistics.

The one or more candidate use cases 1106 may be processed with one or more embedding models to generate one or more candidate use case embeddings and/or one or more search result embeddings. The one or more candidate use case embeddings may be compared with other embeddings (e.g., the one or more search result embeddings) to determine embedding similarities 1110 with other use case embeddings, web result embeddings, and/or query embeddings.

Based on the embedding similarity 1110 determination, one or more badge clusters 1112 may be determined. Each badge cluster may be associated with a set of embeddings determined to be associated with a similar topic or type of topic. The badge clusters 112 may then be stored to be ranked and/or obtained in response to a search query.

Additionally and/or alternatively, candidate use case pairs 1114 may be determined based on the one or more candidate use cases 1106. The candidate use case pairs can be processed with a multi-task unified model 1116, which can generate outputs that may be leveraged to determine whether a first candidate use case and a second candidate use case are similar or not. The similarity determination may be utilized to determine and/or augment clustering 1112. The multi-task unified model 1116 can be trained to identify complex and/or multi-task requests and may be trained to determine a set of actions to be performed to fulfill the multi-task request. The multi-task unified model 1116 can be configured and/or trained to perform the multi-task request fulfillment to reduce the search instances required to reach an end resource being requested by the user. In some implementations, the multi-task unified model 1116 can include one or more generative models (e.g., a generative language model, which may include one or more transformer models). The multi-task unified model 1116 may be leveraged to determine whether the two use cases are associated with similar tasks.

The clustering 1112 can be utilized to generate use case clusters. The use case clusters can be utilized to mitigate redundancy and/or confusion when serving search results to a user. In particular, the search result interface may limit the number of badges from a given cluster (e.g., to one badge per cluster) during search results display to provide a diverse set of search results with a diverse set of badges (and therefore a diverse set of use cases).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
obtaining web data associated with a particular product, wherein the web data comprises web information associated with the particular product;
processing the web data with one or more machine-learned models to determine one or more particular uses associated with the particular product, wherein the one or more particular uses are determined based on the web information;
generating one or more badges based on the one or more particular uses, wherein the one or more badges are descriptive of the one or more particular uses;
storing the one or more badges, wherein the one or more badges are stored with data descriptive of an association with the particular product;
obtaining a search query, wherein the search query is associated with a product type, wherein the particular product is of the product type; and
providing a search results interface based on the search query and the one or more badges.

2. The system of claim 1, wherein the web data comprises user reviews of the particular product.

3. The system of claim 1, wherein the one or more particular uses are determined based on a frequency of a term in the web information, sentiment analysis, and semantic understanding.

4. The system of claim 1, wherein the one or more particular uses are associated with at least one of:
a scenario for using the particular product;
a purpose for using the particular product;
a time for using the particular product; or
a type of user that uses the product.

5. The system of claim 1, wherein the operations further comprise:
processing the one or more badges with an embedding model to generate one or more respective badge embeddings in an embedding space; and
determining a plurality of search results to display in the search results interface based on the one or more badge embeddings.

6. The system of claim 5, wherein determining the plurality of search results comprise:
processing the search query with the embedding model to generate a query embedding;
determining the query embedding is associated with the badge embedding; and
providing a product search result descriptive of the particular product in the search results interface.

7. The system of claim 5, wherein the operations further comprise:
processing a plurality of other badges associated with a plurality of other products with the embedding model to generate a plurality of other badge embeddings;
determining one or more badge clusters based on one or more badge embeddings and the plurality of other badge embeddings; and
determining one or more search results of the search results interface based on the one or more badge clusters.

8. The system of claim 1, wherein providing the search results interface based on the search query and the one or more badges comprises:
determining the one or more badges are associated with the search query;
obtaining product data associated with the particular product, wherein the product data comprises one or more links to one or more web resources associated with the particular product; and
wherein the search results interface comprises a product search result, wherein the product search result comprises data descriptive of the product and the one or more badges.

9. The system of claim 1, wherein the one or more machine-learned models comprise a natural language processing model, and wherein the one or more particular uses are determined based at least in part on sentiment analysis.

10. The system of claim 1, wherein the web information comprises product descriptions and answers to frequently asked questions.

11. A computer-implemented method, the method comprising:
determining, by a computing system comprising one or more processors, one or more web resources associated with an object;
processing, by the computing system, one or more content items of the one or more web resources with one or more machine-learned models to determine at least one of one or more advantages or one or more disadvantages associated with the object;
generating, by the computing system, one or more badges based on the at least one of one or more advantages or one or more disadvantages associated with the object, wherein the one or more badges comprise a generated text label;
obtaining, by the computing system, a search query from a user computing system;
determining, by the computing system, at least one of the object or the one or more badges are associated with the search query; and
providing, by the computing system, a particular object search result for display in a search results interface, wherein the particular object search result comprises data descriptive of the object and a user interface element descriptive of the one or more badges.

12. The method of claim 11, wherein determining, by the computing system, the at least one of the object or the one or more badges are associated with the search query comprises:
processing, by the computing system, the search query with a search engine to determine a plurality of search results;
determining, by the computing system, a set of badges associated with the plurality of search results, wherein the set of badges comprises the one or more badges; and
providing, by the computing system, a set of particular search results in the search results interface based on the set of badges.

13. The method of claim 11, wherein determining, by the computing system, the at least one of the object or the one or more badges are associated with the search query comprises:
determining, by the computing system, a set of badges associated with the search query, wherein the set of badges comprises the one or more badges;
determining, by the computing system, a respective search result for each of the particular badges of the set of badges; and
providing, by the computing system, the set of respective search results in the search results interface based on the set of badges.

14. The method of claim 11, further comprising:
indexing, by the computing system, the one or more badges with data descriptive of the object.

15. The method of claim 11, wherein determining the one or more web resources comprises:
obtaining, by the computing system, data descriptive of the object;
processing, by the computing system, the data descriptive of the object with a search engine to determine a set of object-specific search results; and
selecting, by the computing system, one or more particular object-specific search results from the set of object-specific search results.

16. The method of claim 11, wherein the one or more web resources comprises a web marketplace listing for the object.

17. One or more non-transitory computer-readable media that collectively store instructions that, when executed by one or more computing devices, cause the one or more computing devices to perform operations, the operations comprising:
obtaining a search query, wherein the search query is associated with a particular object type;
processing the search query to determine a plurality of badges associated with the search query, wherein the plurality of badges comprise a plurality of particular advantages associated with a plurality of different objects of the particular object type;
determining a subset of the plurality of badges to display;
obtaining a plurality of search results associated with the subset of the plurality of badges, wherein the plurality of search results comprise one or more respective search results for each particular badge of the subset of the plurality of badges; and
providing a search results interface for display, wherein the search results interface comprises the plurality of search results, wherein each of the plurality of search results is annotated with the particular badge associated with the respective search result.

18. The one or more non-transitory computer-readable media of claim 17, wherein the plurality of badges are generated by processing a plurality of reviews for each of the plurality of different objects.

19. The one or more non-transitory computer-readable media of claim 17, wherein the search results interface comprises a first panel for the plurality of search results and a second panel for a model-generated response, wherein the model-generated response is generated by processing the search query with a language model to generate the model-generated response, wherein the model-generated response is responsive to the search query, and wherein the language model comprises a text-to-text generative model.

20. The one or more non-transitory computer-readable media of claim 17, wherein the plurality of search results comprise a plurality of product search results associated with a particular set of web resources; and
wherein the search results interface comprises a plurality of product search results, a plurality of general search results, and a natural language response, wherein the natural language response is generated with a machine-learned generative model, and wherein the plurality of general search results are determined with a search engine.
